(19) United States
(12) Patent Application Publication
(10) Pub. No.: US 2015/0286774 A1
(43) Pub. Date: Oct. 8, 2015

(54) METHOD AND ARRANGEMENT FOR DETERMINING TRAITS OF A MAMMAL

(71) Applicant: GENOSCOPER OY, Helsinki (FI)

(72) Inventors: Hannes Lohi, Vantaa (FI); Tuomas Poskiparta, Espoo (FI)

(21) Appl. No.: 14/440,164

(22) PCT Filed: Nov. 1, 2013
(86) PCT No.: PCT/FI2013/051038

§ 371 Date: May 1, 2015

(30) Foreign Application Priority Data
Nov. 1, 2012 (FI) 20126143

(51) Int. Cl. G06F 19/22; G06F 19/00

(52) U.S. Cl. CPC G06F 19/22; G06F 19/3431

(57) ABSTRACT

A system for determining traits for an individual mammal includes a first database with genomic data of known traits as well as identified correlations including details of the trait, mutation, disease risk and/or affected breeds of a mammal species, and a second database based on a gene test made for the individual mammal, the database including genotyping data of the individual mammal to be analyzed. A plurality of markers is determined for regions in the mammal's genome so that at least first portion of the markers relates to correlations in various known gene based traits, and at least second portion of the markers used in determining differs from the first portion of the markers. Then the genotyping data of the individual mammal's genome corresponding to the first portion of the markers is compared in order to make correlations and thereby determine a probability or risk or severity of the traits.

### TECHNICAL FIELD OF THE INVENTION

The invention relates to a method and arrangement for determining traits, such as health risks for a mammal. In particularly the invention relates to analysing genomic data of the mammal in order to achieve probability or severity of different traits of the mammal, such as disease, morphology and/or behaviour traits.

### BACKGROUND OF THE INVENTION

Gene discoveries enable genetic tests for breeding purposes. For example DNA test can discriminate genetically normal, carrier and affected mammals from each other and help breeders to improve breeding plans. Veterinarians can use tests as diagnostic tools. Systematic and careful use of the DNA tests may help to reduce the incidence of the diseases in the breed or even eradicate them from the populations while maintaining necessary genetic diversity. This is very important for example in dog, cat and horse breeding, but also with more rare breeds, such as of llama, camel or zebra.

Genetic traits can be inherited in many ways. A common mode of inheritance in inbred populations is autosomal recessive, although some dominant and X-linked traits exist. These so called Mendelian traits cause usually single gene disorders. However, it is important to keep in mind that the penetrance of the disease may vary and individuals with the same mutation may differ. Many common disorders are also polygenic affected by several genes and environmental factors. Each genetic loci contributes to the disease risk and the disease outcome is defined by the combination of risk genes and environmental factors.

Public annotations of domestic animal genomes including among others dogs and horses greatly produce bio-informational data of gene discoveries for diseases, conformation, performance, ancestry and genetic diversity. Simultaneous rapid development of economic high-resolution sequencing technologies revolutionizes DNA diagnostics and transforms the field from the analysis of targeted genetic regions to the interpretation of the entire genomes of individual animals. This type of extensive genome wide information allows simultaneous analysis of various properties or features of the tested mammal, including information such as ancestry or parentage, genetic diversity, multiple disease, morphological and behavioural traits. However, the analysis or interpretation of the genomic data requires prior information about the correlation of a specific marker or markers with particular phenotype or phenotypes.

Although the next generation sequencing (NGS) technologies allow genome wide analyses of individual animals, there are disadvantages in the generation and interpretation of the genomic data. The challenges are related to the technical quality and reliability of the NGS data, to the large amount, mining and storage of the data for bioinformatics interpretation and to the expensive cost of the laboratory experiments. Thus in order to test or determine plurality of trait of the mammal takes time and is therefore quite expensive

The other disadvantages include the lack of proper systems for existing trait correlations that makes the interpretation of the data very slow and complicated. In addition, the known trait-specific correlated DNA markers can be of many different types such as single nucleotide polymorphism (SNP), microsatellite (di- or tetranucleotide repeats), indels, block substitutions, inversions or copy number variant (CNV). Currently, there has not been a single reliable cost efficient technology that could read or sequence all different types of markers simultaneously from targeted regions of the genome of an tested animal for a comprehensive genetic analysis of the animal's ancestry, health risk, morphology and behaviour.

### SUMMARY OF THE INVENTION

An object of the invention is to alleviate and eliminate the problems relating to the known prior art. Especially the object of the invention is to provide a method and an arrangement or system for determining and analysing traits, such as health risks for an individual mammal, by analysing genomic data of said individual mammal. In particularly the object is to achieve or produce bio-information, such as information relating to evaluation of genetic potential of said mammal in relation to at least health risks, conformation, behaviour or breeding, in a suitable form for determining a value of health or disease risks and/or breeding value of said individual mammal said value comprising information of plurality of traits, such as disease, morphology and/or behaviour traits, of said individual mammal in parallel.

The object of the invention can be achieved by the features of independent claims.

The invention relates to a method for determining plurality of traits of a mammal according to claim 1. In addition the invention relates to an arrangement for determining plurality of traits of a mammal according to claim 14, as well as to a computer program of claim 15.

According to an embodiment a first database (such as Scientific research DB) having markers is provided. Marker means according to an exemplary embodiment a known trait (e.g. disease, morphology, behaviour) —causing mutation (SNP, indel, CNV) or associated risk marker (SNP). The first database comprises genomic data of known traits as well as identified correlations comprising details of mutation, disease risk and affected breeds of at least one mammal species. The term “correlation” is used here for a specific genomic variation that has been associated with or shown to modulate or affect the disease, morphology or behaviour, but it may also be a statistical association or is often supported by functional evidence.

Said data in the first database advantageously relates to scientific research, which identifies new genes for example for different canine traits including disease, morphology and behaviour. Identified correlations are provided in said first database including the details of the mutation, disease risk and the affected breeds. The first database may also comprise a compiled literature of the known correlations in various traits to be included in a so called bundle gene test according to embodiments of the invention. According to an example the first database comprises data of loci (specific location of a gene or DNA sequence on a chromosome) and markers which are to be tested for the individual mammal in question in order to provide a DNA-profile with numbers of the locus for said individual mammal.

In addition, a first data, such as genomic data of the individual mammal is provided. The genomic data for gene tests and analysis can be achieved for example from blood or a cheek swab samples. Thus also a second database is provided based on the gene test made for said individual mammal, said database comprising analysed genomic data, i.e. genotyping data of said individual mammal.

In order to achieve bio-information of the mammal in question, plurality of different markers (as a bundle) for regions in the mammal's genome from the genomic data of said second database is determined and analysed in parallel. The utilized markers comprise advantageously at least two portions, namely a first portion and second portion. According to an embodiment the first portion of the markers comprises over 50 markers, more advantageously over 100 markers and most advantageously over about 150 markers, the majority of which are advantageously disease or other trait-related markers, which relates to correlations in various known gene based traits. According to an embodiment the second portion of said markers (differing from said first portion) comprises advantageously over 200 markers, more advantageously over about 500 markers and most advantageously over about 800 markers, relating to microsatellite- and/or SNP-based (single nucleotide polymorphism) markers. These “neutral” markers can be used to investigate the ancestry, parentage and genetic diversity of the animal (and populations) and can be used also partially to tag disease loci complementing the first portion of the markers. These markers can be also utilized to make new trait correlations given that specific phenotype information is collected from a sufficient number of animals (cases and controls) to allow such statistical approaches.

In the determination and analysing the genotyping data of the individual mammal's genome corresponding to said first portion of said markers is compared with corresponding genotyping data of said first database in order to make correlations between said determined regions and data of said first database and thereby determine probability or risk (severity) of the traits. Also DNA profile (such as identity, relatedness, genetic diversity, colour, fur type, conformation, behaviour, parentage, ancestry, etc.) of said mammal is determined based on the genotyping data of the mammal's genome corresponding to said second portion of said markers.

According to an embodiment an individual index is determined for health related traits and genetic diversity trait(s) for the individual mammal to determine the value of health or disease risks and/or breeding value of said individual mammal. This may advantageously comprise
comparing the genotyping data of the said individual mammal's genome corresponding to said first portion of said markers with corresponding genotyping data of said first database in order to make correlations between said determined regions and data of said first database and thereby determine a probability or risk or severity of the traits, as well as determining DNA profile of said individual mammal based on the genotyping data of the said individual mammal's genome corresponding to said second portion of said markers,
providing a weighted coefficient for each of said traits based on the determined probabilities or risks or severities of the traits, and
combining said weighted coefficients in order to provide said individual (overall) index for said individual mammal.

The using of plurality of different markers, both from the first and second portions (as a bundle test), makes the method very effective, since numerous different traits can be determined simultaneously. The test is as an expandable bundle test comprising advantageously about or over 1000 regions in each mammal's genome, which may comprise 200 disease traits, colour, fur type, conformation, behaviour, pharmacogenomics, DNA profile, parentage and ancestry, as well as relatedness and genetic diversity (SNPs and microsatellites). It is to be noted that the new markers can be included in the bundle test afterwards, whereupon only the new markers (regions, not yet determined) is analysed from the mammal's genome by subsequent determinations, which saves time and money.

This type of bundle testing provides most comprehensive information of the animal's genome from a single laboratory in a single assay to date and avoid multiple samplings of the animal for various laboratories and for different tests of single use. Bundle testing offer also the most comprehensive data for different type of ancestry and population genetic studies that are useful for breed clubs and associations the develop their breeding programs for simultaneous avoidance of unwanted risk alleles and for beneficial genetic diversity of the population or breed in question. A single bundle assay covering most if not all of the known traits helps breed clubs to compile important breed-specific genomic data easily instead of collecting it tediously from various sources and laboratories. A comprehensive bundle database combined with other phenotypic databases forms a new advantageous basis for animal breeding. Furthermore, the bundle provides an efficient mean of testing the frequency of presence of the known mutations or risk markers of traits in breeds that have never been tested before, therefore, giving an opportunity for the discovery of new affected breeds. This information is important to avoid the enrichment of the potential disadvantageous mutations in the new breeds as well as for the diagnostics of the disease in the affected breeds.

After analysing and determination the probability or severity of the traits of the mammal, as well as DNA profile, may be reported as results advantageously visually via a graphical interface and/or via simplified numerical data. Said results may be reported or visualised for example by using fourfold table, or Gaussian curve so that one can see e.g. health risks in one go or at a glance. It is to be noted that according to an embodiment the “result” (or individualised index provided for said individual mammal) may also be used in other ways than only for reporting purposes, such as for breeding and matchmaking purposes described elsewhere in this document.

According to another embodiment also a third database is provided with phenotype data of said individual mammal, whereupon the invention further comprises providing and/or reporting at least portion of said phenotype data together with said probability or severity of the traits of said mammal e.g. via said graphical interface and/or via simplified numerical data. Said third database may comprise phenotype data for example of at least affected (suffers from a disease or has a particular morphology or behaviour) and/or unaffected (normal or healthy control without a trait) traits for certain mammals. In addition according to an embodiment at least portion of said phenotype data and genotyping data of mammals may be compared with each other in order to identify a possible new trait or disease related correlation.

The phenotype data can be achieved e.g. so that phenotypic profiles for the mammals can be filled out e.g. via data processing systems. The system may offer an opportunity to participate in scientific studies with more in-depth surveys. According to an embodiment new correlations between the genotypic data and phenotypic data may be provided by comparing portions of said two different data with each other, such as to define new genetic correlations, to provide large study cohorts to academic research groups, to partnership with mammal food and pharmacy industries for the development of better products or to improve the fidelity of the existing ones.

According to an embodiment of the invention also matchmaking of different mammals can be performed so that phenotypic data (e.g. morphology and behaviour) and/or genotyping data of plurality of different mammals are compared with each other in order to strengthen or weaken a certain trait(s). This can be implemented for example so that a certain trait(s) to be strengthen is selected for a first mammal, whereupon another mammals of the same species are analysed alternately and a mammal which has highest probability (or other comparable value) for that selected trait(s) is proposed as a best match. Oppositely done that trait(s) is weakened. Similarly genetic diversity/vitality can be increased or enhanced, as well as also an ancestrial line can be identified.

Still, according to an embodiment of the invention a DNA-pass may be provided for each mammal with a specific ID number or other ID related data. The specific ID number can be used for:
an easy access to the databases, such as disease-specific genetic data database, in order to achieve stored data and/or inputting new data, such as phenotype data, into the database, and
providing access to the representation of the traits based on the stored genotype and/or phenotype data of said mammal via said graphical interface and/or via simplified numerical data.

The reporting of the results or analysis is overall performed advantageously via an online reporting system that comprises genomic and/or phenotype data-based mammal's health and genetic diversity indexes, relatedness to other mammals in the breed, parentage and ancestry information.

### Exemplary Implementation

In the following one exemplary implementation of the invention is described as an example. This should not be interpreted to limit the scope of the claims only to this specific example. According to an exemplary embodiment the invention relates in particularly for determining health risks, disease risks, morphology and/or behaviour of an individual mammal by analysing, amongst other, genomic data of said individual mammal.

In order to achieve genomic data or bio-information, a DNA sample isolated from a tissue of the mammal is subjected to an analysis by a genome wide gene test. This test typically contains a number N of markers for different genetic diseases, conformations, DNA identification and genetic diversity to be analysed and thereby to achieve genotyping data. The number N of markers might be 3000, 5000, 7000 or over 9000 thousands, for example, depending on the accuracy desired. This genotyping determines the actual genotype in each locus of the tested individual mammal. This genotyping data is advantageously arranged in a second database.

The determined genotype can have three alternate nucleotide forms in each locus, for example, AA, AG or GG. For example, in recessive condition, if the individual is determined GG, it will become affected. If individual is AG then it carries the mutation but does not get affected but may pass it to the next generation if used for breeding. “AA” individual would be free of mutation and the disease.

The significance of each genotype for the health risk or other treats is defined by the first database. Thus the first database comprises advantageously genomic data of known traits as well as previously identified correlations comprising details of the trait, mutation, disease risk and/or affected breeds of mammal species of said individual mammal. This data related to genomic data of known traits can be achieved from the common knowledge, such as literature or the like. The identified correlations to the first database are determined by the inventors via their experiments and tests.

According to the invention the plurality of markers are determined for different regions in the mammal species genome to be determined and analysed from the genomic data of said individual mammal in the second database. The first portion of the markers relates to correlations in various known gene based traits, such as diseases. In other words the first markers relate to a certain regions in the mammal species genome, which regions has a certain correlation (may be e.g. weighted correlation or coefficient) with a certain disease. In addition the second portion of said markers (2^{nd} markers) used in determining differs from said first portion of said markers (1^{st} markers). In practice the 2^{nd} markers do not relate to any such special correlations in various known gene based traits, such as to diseases, that is the case with 1^{st} markers. The 2^{nd} markers are used mainly for determining diversity of said individual mammal in relation to general population of said species.

According to the example each disease marker (1^{st} marker) has been pre-weighted by a coefficient factor varying from 0-1, based on the severity as determined by the inventor via his experiments and tests into the first database. Genotyping data of markers determined from the DNA sample are submitted to the second database. Genotyping data of said individual mammal's genome for said number or markers N in the second database is then computationally compared, marker by marker (at least 1^{st} markers) with corresponding genotyping data of said first database, in order to make correlations between said determined regions and data of said first database and thus to determine the genetic composition of the mammal in relation to the specified markers (1^{st} markers) in the first database. In this way a probability or risk or severity of the traits can be determined. In addition also a DNA profile (representing diversity) can be determined for said individual mammal based on the genotyping data of said individual mammal's genome corresponding to said second portion of said markers (2^{nd} markers).

This comparison provides information about which diseases (in this example among 100+ tested, but naturally this can vary) the animal carries (is heterozygous for the risk marker in a recessive condition, for example, AG) and may become affected (is homozygous for the disease marker in a recessive condition, for example, GG) and how genetically diverse, e.g. heterozygous the animal is over the certain number or markers (2^{nd} markers differing said 1^{st} markers) excluding the disease markers (for example it might be that 5000 markers are heterozygous and 2000 homozygous for a certain individual mammal).

The plurality of the data from multiple markers, of which a portion related to health markers (1^{st} markers) are weighted according to severity of the condition as defined in the first database, are then combined to determine the overall genetic health index for an individual using a mathematical equation with predefined coefficients. The combination can be used for example by mathematical operations, such as summarizing (probably the simplest version of the example) the weighted markers, but also more complex operations can be used for more detailed and accurate test. For example the numerical index relating to a certain disease can be weighted in view of it severity for example by a factor of power 2 (as an example, the power depending on the severity), to put weight on sever conditions. In addition numerical values of the disease markers (1^{st} markers, depending on its severity) decreases the overall genetic health index of said individual mammal, whereas the diversity markers (2^{nd} markers) increases the overall genetic health index of said individual mammal.

In the example the calculation is averaged to 100, for example. For instance the individual whose heterozygosity for a certain number N of diversity markers (2^{nd} markers) in the database is average, gets value 100, and individuals who are better, above 100. If the individual is genetically diverse (less inbred) and does not carry any disease markers as defined in the first database, it will have a high genetic health index. Similarly, if the individual carries multiple severe disease markers and has a low overall genome wide heterozygosity level, its index will be low. For example dogs that carry Mendelian single gene disorders (most of the tested disorders) get risk value 0.5.

This example above describes an exemplary implementation of the invention how to determining an individual index for health related traits and genetic diversity trait(s) for an individual mammal and how to determine the value of disease risks and/or breeding value of said individual mammal. However it is to be noted that the numerical values above are only examples and can vary depending on the conditions of the embodiment, such as severity determined via experiments or accuracy desired, and thus they should not be interpreted as limiting the scope of the claims.

The invention offers many advantages over the known prior art, such as an efficient tool to greatly facilitate the rate of gene based discoveries for diseases, conformation, performance, ancestry and genetic diversity (through accumulation of samples as well as phenotype and genotype information). In addition the invention allows an easy and rapid way to interpret of at least appropriate genomes of individual animals. The invention also enables parallel analysis of genomic variants for multiple traits and provides more holistic tools for breeders and veterinarians, as well as improves diagnostics and advance the health and welfare of the animals. Especially the invention allows easily determine probabilities or severities of different diseases (e.g. certain eye diseases), predict the disease risk based on the genotype, distinct carriers and non-carriers in the breed to improve breeding decisions to eliminate disease from the breed, as well as to keep healthy carriers in breeding programs to maintain genetic diversity. Moreover the provided information related to probability or severity of the traits of the mammal as well as DNA profile can be used for providing e.g. individualized nutrition, dietary, medication, exercise or training.

The first database or so called literature database of the invention compiles the list and interpretation of the latest canine gene tests and is very useful for veterinarians, academic and canine community for provide information on trait correlations and related risks in a single site.

Moreover the more comprehensive bundle test including genetic information from hundreds of loci provides more efficient tool for DNA identification of the animal, improving the reliability of the parental testing and providing an efficient tool for forensic investigations, e.g. criminal investigations related to animals.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary arrangement for determining plurality of traits of a mammal according to an advantageous embodiment of the invention, and

FIGS. 2A-2C illustrates exemplary devices or interfaces for reporting results of the determination according to an advantageous embodiment of the invention.

### DETAILED DESCRIPTION

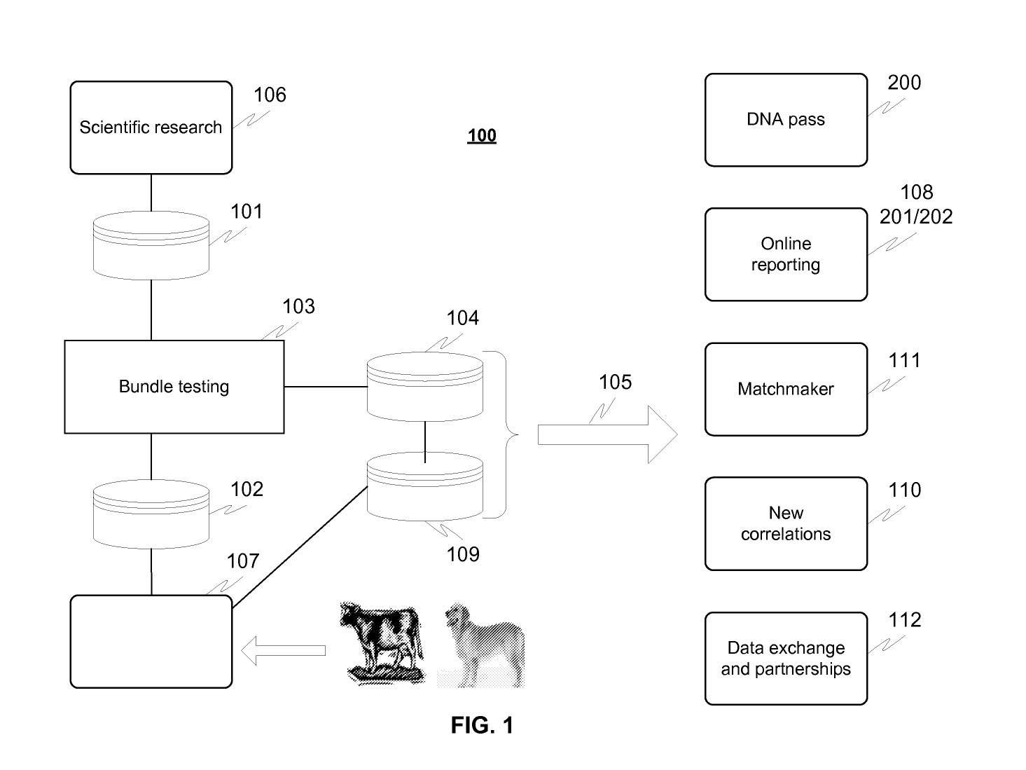

FIG. 1 illustrates a principle of an exemplary arrangement or system 100 for determining plurality of traits of an individual mammal according to an advantageous embodiment of the invention, wherein the arrangement comprises a first database 101 or at least an access to it, as well a second database 102 or at least an access to it. Data to the first database 101 is provided e.g. by scientific research end 106, which identifies new genes for example for different canine traits including disease, morphology and behaviour, or loci, as describes elsewhere in this document. The first database 101 advantageously comprises genomic data of known traits as well as identified correlations comprising details of mutation, disease risk and/or affected breeds of mammals. Data to the second database 102 is provided e.g. by breeders, farmers or the like, such as dog owners, advantageously via an end 107, which makes gene test made for mammals. Advantageously the second database comprises genotyping data—or at least portion of it—of the individual mammal to be analysed, read e.g. via gene tests. Genomic data for the gene test may be achieved for example by a cheek swab samples.

The arrangement 100 also comprises a determining means 103 for determining plurality of markers for regions in the mammal's genome to be determined advantageously in parallel and analysed from the genomic data of said second database 102. The markers may be predetermined, whereupon the determining means 103 is configured to manage the analysis process of the genomic data so that an appropriate bundle of plurality of markers for a certain individual mammal is searched. The bundle of plurality of markers advantageously comprises at least a first portion, so called, mutation markers, which relates to correlations in various known gene based traits. The bundle also advantageously comprises at least a second portion of markers, such as microsatellite- and/or SNP-based markers.

In addition the arrangement 100 is also configured to compare 103, 104 the genotype data of the individual mammal's genome (data from the second database 102) with the corresponding genotyping data (scientific research data) of said first database 101 in order to make correlations between said determined regions and data of said first database. In particularly regions of the mammal's genome is determined, which correspond to the first portion of the markers as well as also to the second portion of the markers so that probability or risk (severity) of the traits is determined via the first portion and DNA profile is determined via the second portion.

According to an embodiment the arrangement may be adapted to determine an individual index for health related traits and genetic diversity trait(s) for the individual mammal in order to determine the value of health or disease risks and/or breeding value of said individual mammal. This may advantageously comprise
comparing 103, 104 the genotyping data of the said individual mammal's genome 102 corresponding to said first portion of said markers with corresponding genotyping data of said first database 101 in order to make correlations between said determined regions and data of said first database and thereby determine 103, 104 a probability or risk or severity of the traits, as well as determining DNA profile of said individual mammal based on the genotyping data of the said individual mammal's genome corresponding to said second portion of said markers,
providing 105 a weighted coefficient for each of said traits based on the determined probabilities or risks or severities of the traits, and
combining 105 said weighted coefficients in order to provide said individual (overall) index for said individual mammal.

Moreover the arrangement 101 may comprise reporting means 108 for providing and/or reporting 105, 106 the determined probability or severity of the traits of the mammal as well as DNA profile. The reporting is advantageously implemented via a graphical interface 108, 200, 201, 202 and/or via simplified numerical data 200.

According to an embodiment the arrangement 100 may also comprise a third database 109 for phenotype data of individual mammals. Thus the arrangement is advantageously configured to determine, analyse and report also at least portion of said phenotype data together with said probability or severity of the traits of said mammal via said graphical interface and/or via simplified numerical data. The third database may comprise e.g. phenotype data of at least affected and/or unaffected mammals for a certain trait. It is to be noted that the arrangement may also be configured to compare at least portion of said phenotype data and genotyping data of mammals in order to identify 103, 110 a new trait or disease related correlation.

The arrangement 100 may also comprise application 112 configured to produce new correlations between the genotypic data and phenotypic data e.g. by comparing portions of the two different data with each other in order to provide large study cohorts to academic research groups, to partnership with dog food and pharmacy industries for the development of better products or to improve the fidelity of the existing ones.

Still, according to an embodiment the arrangement may comprise an application for matchmaking for breeding purposes 111 of different mammals so that phenotypic data (e.g. morphology and behaviour) and/or genotyping data of plurality of different mammals are compared with each other in order to strengthen or weaken a certain trait(s). This is implemented according to an exemplary embodiment so that the customer gives first the desired phenotypic characteristics (morphology, color, temperament, hunting skills) and possible wanted competition results (field competitions and show results) of the candidate dogs to the system, which then scans the set databases for best matches and shows them in a ranked order. This is followed by the simultaneous comparison of the genomes of the target and the best query dogs to identify potential genetic risks or benefits.

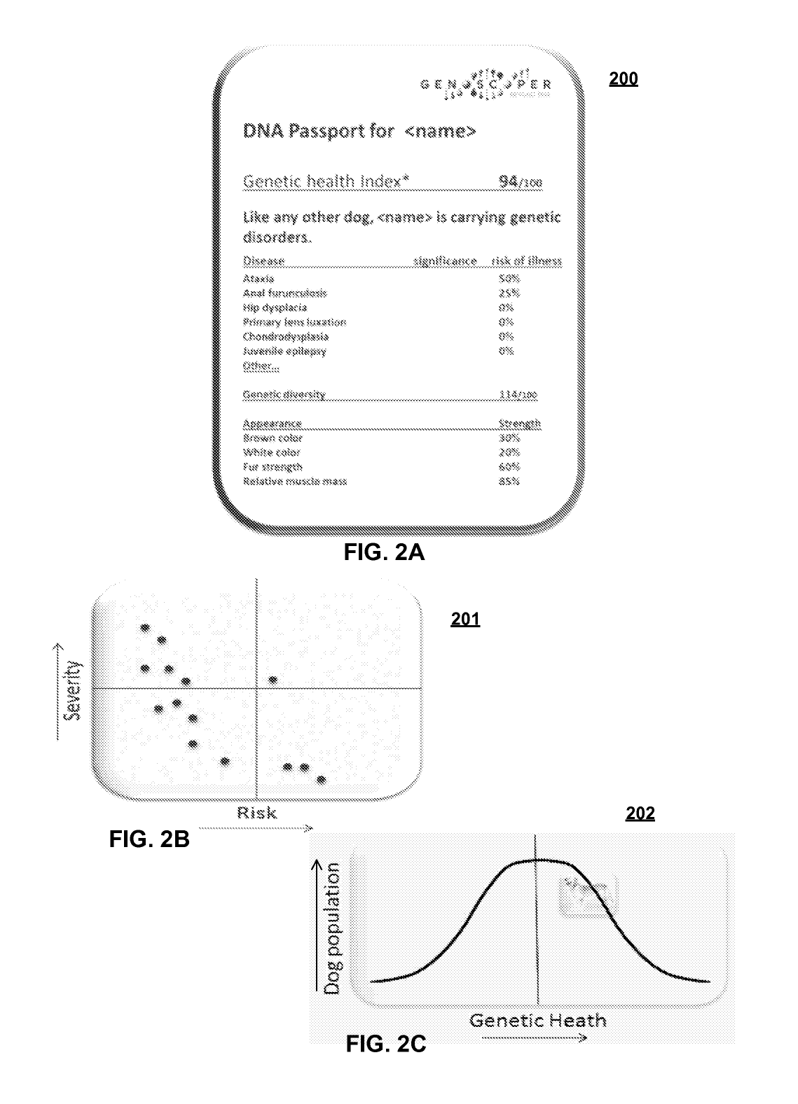

FIGS. 2A-2C illustrates exemplary devices or interfaces 200, 201, 202 for reporting results of the determination according to an advantageous embodiment of the invention.

FIG. 2A illustrates an embodiment of a DNA-pass 200 provided for each mammal. The DNA-pass may comprise a specific ID number, which can be used for
an easy access to the databases 102, 103 (such as to the disease-specific genetic data database or phenotype database in order to store phenotype data) in order to achieve stored data and/or inputting new (phenotype data) data into the database 102, 103, and
providing access to the representation 108, 201, 202 of the traits based on the stored genotype and/or phenotype data of said mammal via said graphical interface (see FIGS. 2B, 2C) and/or via simplified numerical data.

The reporting may be performed according to an embodiment via online reporting system 108, 201, 202, as is illustrated in FIGS. 2B, 2C. For example FIG. 2B represents an example of a fourfold table, where the severity and/or risk of plurality of different traits of the mammal in question can be understood at a glance. As is depicted in FIG. 2B only one trait with a high risk has severity over a threshold. The reporting system may be configured so that when choosing said trait (e.g. by pointing it), the reporting system will output more detailed description of the trait in question. Similarly FIG. 2C represents an alternative way to report the results via Gaussian.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims. It is to be noticed that even though different databases are discussed above, they can also be implemented by a same physical database arrangement for example by allocating separated data structures for different types of data. In addition even if only few mammals are discussed as an example, the invention is not limited only to those but can be used in connection with different kinds of breeds and mammals.

1-15. (canceled)

16. A method for determining plurality of traits, comprising health risks, disease risks, morphology and/or behaviour, of an individual mammal in parallel by analyzing of a first data, comprising genomic data of said individual mammal in order to achieve bio-information to determine the disease risks and/or breeding value of said individual mammal, wherein the method comprises:
providing a first database comprising genomic data of known traits as well as identified correlations comprising details of the trait, mutation, disease risk or affected breeds of mammal species of said individual mammal,
providing a second database based on a gene test made for said individual mammal, said database comprising genotyping data of said individual mammal to be analyzed,
determining plurality of markers for regions in the mammal species genome to be determined and analyzed from the genomic data of said individual mammal in the second database, where
at least first portion of said markers relates to correlations in various known gene based traits, and
at least second portion of said markers used in determining differs from said first portion of said markers,
determining an individual index for health related traits and genetic diversity traits for said individual mammal to determine the value of disease risks and/or breeding value of said individual mammal, comprising:
comparing the genotyping data of said individual mammal's genome corresponding to said first portion of said markers with corresponding genotyping data of said first database in order to make correlations between said determined regions and data of said first database and thereby determine a probability or risk or severity of the traits, as well as determining DNA profile for said individual mammal based on the genotyping data of said individual mammal's genome corresponding to said second portion of said markers,
providing a weighted coefficient for each of said traits based on the determined probabilities or risks or severities of the traits,
combining said weighted coefficients in order to provide said individual index for said individual mammal.

17. A method of claim 16, wherein the method comprises reporting said probability or severity of the traits of said mammal as well as DNA profile via a graphical interface and/or via simplified numerical data.

18. A method of claim 16, wherein said second portion of said markers relates to microsatellite- and/or SNP-based markers.

19. A method of claim 16, wherein the first portion of said markers comprises over 50 markers, more advantageously over 100 markers and most advantageously over about 150 markers, the majority of which are disease markers or markers associated with morphological, comprising conformation, colour, fur type, hair length, or behavioural traits of the animal.

20. A method of claim 16, wherein the second portion of said markers comprises advantageously over 200 markers, more advantageously over about 500 markers and most advantageously over about 800 markers, relating to microsatellite- and/or SNP-markers.

21. A method of claim 16, wherein a third database is provided with phenotype data of said individual mammal, whereupon the method further comprises providing or reporting at least portion of said phenotype data together with said probability or severity of the traits of said mammal for example via a graphical interface or via simplified numerical data.

22. A method of claim 21, wherein said third database comprises phenotype data of at least affected or unaffected mammals for a certain trait and the method further comprises step of comparing at least portion of said phenotype data and genotyping data of mammals in order to identify a new trait or disease related correlation.

23. A method of claim 16, wherein genomic data for the gene test is achieved to the second database by a cheek swab samples.

24. A method of claim 16, wherein the method comprises the step of a matchmaking function, where phenotypic data, comprising morphology and behaviour, or genotyping data of plurality of different mammals are compared with each other so that the properties of a mammal to be looked for is defined as input data, whereupon said input data is compared for the database information to identify the closest matches that are then directed for genomic comparisons to avoid disease and to increase diversity
in order to strengthen or weaken a certain traits,
in order to increase/enhance genetic diversity/vitality, or
in order to identify an ancestrial line,
whereupon the closest matches is proposed as a most suitable match based on inputs.

25. A method of claim 16, wherein a DNA-pass is provided for each individual mammal with a specific ID number, and that specific ID number is used for
an access to said databases in order to achieve stored data and/or inputting new data into the database, and
providing access to the representation of the traits based on the stored genotype and/or phenotype data of said mammal via said graphical interface and/or via simplified numerical data.

26. A method of claim 16, wherein the reporting is performed advantageously via online reporting system that comprises genomic or phenotype data-based individual mammal's health and genetic diversity indexes, relatedness to other mammals in the breed, parentage and ancestry information.

27. A method of claim 16, wherein the method additionally comprises a step for providing new correlations between the genotypic data and phenotypic data by comparing portions of said two different data with each other.

28. A method of claim 16, wherein said provided information related to probability or severity of the traits of said individual mammal as well as DNA profile is used for providing nutrition, dietary, medication, exercise, and/or training.

29. An arrangement for determining plurality of traits, comprising health risks, disease, morphology or behaviour, of an individual mammal in parallel by analyzing of a first data, such as genomic data of said individual mammal in order to determine the disease risks or breeding value of said individual mammal, wherein the arrangement comprises:
an access to a first database comprising genomic data of known traits as well as identified correlations comprising details of mutation, disease risk or affected breeds of mammal species of said individual mammal,
an access to a second database, data of said database based on a gene test made for said individual mammal, said database comprising genotyping data of said individual mammal to be analyzed,
determining device for determining plurality of markers for regions in the mammal's genome to be determined in parallel and analyzed from the genomic data of said individual mammal in the second database, where
at least first portion of said markers relates to correlations in various known gene based traits, and
at least second portion of said markers used in determining differences from said first portion of said markers,
determining device for determining an individual index for health related traits and genetic diversity traits for said individual mammal to determine the disease risks or breeding value of said individual mammal, said determining device is adapted to:
compare the genotyping data of said individual mammal's genome corresponding to said first portion of said markers with corresponding genotyping data of said first database in order to make correlations between said determined regions and data of said first database and thereby determine probability or risk or severity of the traits, as well as determining DNA profile of said individual mammal based on the genotyping data of said individual mammal's genome corresponding to said second portion of said markers,
providing a weighted coefficient for each of said traits based on the determined probabilities or risks or severities of the traits,
combining said weighted coefficients in order to provide said individual index for said individual mammal.

30. A computer program product for determining a plurality of traits, comprising health risks, disease, morphology or behaviour, of an individual mammal in parallel by analyzing of a first data, such as genomic data of said individual mammal in order to determine the value of health and breeding of said individual mammal, wherein the computer program product comprises program code means stored on a computer-readable medium, which code means are arranged to perform the following steps, when the program is run on a computer:
providing a first database comprising genomic data of known traits as well as identified correlations comprising details of the trait, mutation, disease risk or affected breeds of mammal species of said individual mammal,
providing a second database based on a gene test made for said individual mammal, said database comprising genotyping data of said individual mammal to be analyzed,
determining plurality of markers for regions in the mammal species genome to be determined and analyzed from the genomic data of said individual mammal in the second database, where
at least first portion of said markers relates to correlations in various known gene based traits, and
at least second portion of said markers used in determining differs from said first portion of said markers,
determining an individual index for health related traits and genetic diversity traits for said individual mammal to determine the value of disease risks and/or breeding value of said individual mammal, comprising:
comparing the genotyping data of said individual mammal's genome corresponding to said first portion of said markers with corresponding genotyping data of said first database in order to make correlations between said determined regions and data of said first database and thereby determine a probability or risk or severity of the traits, as well as determining DNA profile for said individual mammal based on the genotyping data of said individual mammal's genome corresponding to said second portion of said markers,
providing a weighted coefficient for each of said traits based on the determined probabilities or risks or severities of the traits,
combining said weighted coefficients in order to provide said individual index for said individual mammal.

31. A computer program product comprising a non-transitory computer readable medium encoded with a computer program according to claim 30.
